(19) United States
(12) Patent Application Publication
(10) Pub. No.: US 2021/0299806 A1
(43) Pub. Date: Sep. 30, 2021

(54) MACHINING APPARATUS AND CUTTING METHOD

(71) Applicant: National University Corporation Tokai National Higher Education and Research System, Nagoya-shi (JP)

(72) Inventor: Eiji SHAMOTO, Nagoya-shi Aichi (JP)

(21) Appl. No.: 17/196,294

(22) Filed: Mar. 9, 2021

Related U.S. Application Data
(63) Continuation of application No. PCT/JP2020/014709, filed on Mar. 30, 2020.

(51) Int. Cl. B23Q 15/013; B23C 1/02

(52) U.S. Cl. CPC B23Q 15/013; B23C 1/02

(57) ABSTRACT

A motion mechanism moves a workpiece relative to a cutting tool with a convex cutting edge. A controller controls the relative movement between the workpiece and the cutting tool by the motion mechanism and an orientation of the cutting tool. The controller intermittently or continuously changes the orientation of the cutting tool to cause a part of the cutting edge that has not been used for cutting to form a finished surface.

### CROSS REFERENCE TO RELATED APPLICATIONS

This application is based upon and claims the benefit of priority from International Application No. PCT/JP2020/014709, filed on Mar. 30, 2020, the entire contents of which are incorporated herein by reference.

### BACKGROUND

### 1. Field of the Disclosure

The present disclosure relates to a technique for suppressing or avoiding wear on a cutting edge.

### 2. Description of the Related Art

When hard nitrides, oxides, or the like are present in a surface layer of a workpiece, a cutting edge for use in cutting the surface layer tends to be damaged. JP 2018-135596 A discloses a method in which diffusion nitriding is applied to a surface of steel by electron-beam-excited-plasma nitriding to form, on the surface of the steel, a solid solution layer substantially free of nitrides. Forming the surface layer of the workpiece substantially free of nitrides makes it possible to reduce the possibility of chipping a cutting edge when cutting process is performed on the surface layer.

It is inevitable that wear on the cutting edge will progress as the cutting distance or cutting time increases, but when a worn cutting edge is used, the shape of the worn cutting edge is transferred to the surface of the workpiece, preventing the surface of the workpiece from being finished with high accuracy.

Further, even when a surface layer substantially free of nitrides is formed by the method disclosed in JP 2018-135596 A, it is difficult to completely eliminate the nitrides, and the possibility of chipping the cutting edge cannot be said to be zero.

### SUMMARY

The present disclosure has been made in view of such circumstances, and it is therefore an object of the present disclosure to provide a technique for suppressing or avoiding wear on a cutting edge for use in cutting.

In order to solve the above-described problem, a machining apparatus according to one aspect of the present disclosure includes a motion mechanism structured to move a workpiece relative to a cutting tool with a convex cutting edge, and a controller structured to control the relative movement between the workpiece and the cutting tool by the motion mechanism and an orientation of the cutting tool. The controller intermittently or continuously changes the orientation of the cutting tool to cause a part of the cutting edge that has not been used for cutting to form a finished surface.

A cutting method according to another aspect of the present disclosure includes moving a workpiece relative to a cutting tool with a convex cutting edge, and controlling an orientation of the cutting tool. In the controlling an orientation, the orientation of the cutting tool is changed intermittently or continuously to cause a part of the cutting edge that has not been used for cutting to form a finished surface.

### BRIEF DESCRIPTION OF THE DRAWINGS

FIG. 1 is a diagram schematically showing a scene of an experiment;

FIG. 2 a picture capturing an appearance of a mirror-surface cut machined object;

FIG. 3 is a picture capturing a finished surface of a machined object under a differential interference contrast microscope;

FIG. 4 is a diagram showing results of measuring a cross-sectional contour of the finished surface in a pick feed direction;

FIG. 5 is a picture capturing a cutting edge of a diamond cutting tool;

FIG. 6 is a diagram showing results of measuring a relationship between a cutting distance and finished surface roughness;

FIG. 7 is a picture capturing the cutting edge of the diamond cutting tool;

FIG. 8 is a diagram showing results of measuring the relationship between the cutting distance and the finished surface roughness;

FIG. 9 is a diagram schematically showing a structure of a machining apparatus according to an embodiment; and

FIG. 10 is a diagram schematically showing a scene of machining according to the embodiment.

### DETAILED DESCRIPTION

The disclosure will now be described by reference to the preferred embodiments. This does not intend to limit the scope of the present disclosure, but to exemplify the disclosure.

Process of cutting a workpiece using the same part of the cutting edge is performed in the related art. The present discloser, by conducting the following Experiment 1, has found a problem in cutting process using the same part of the cutting edge, particularly when a highly accurate finished surface is required.

### Experiment 1

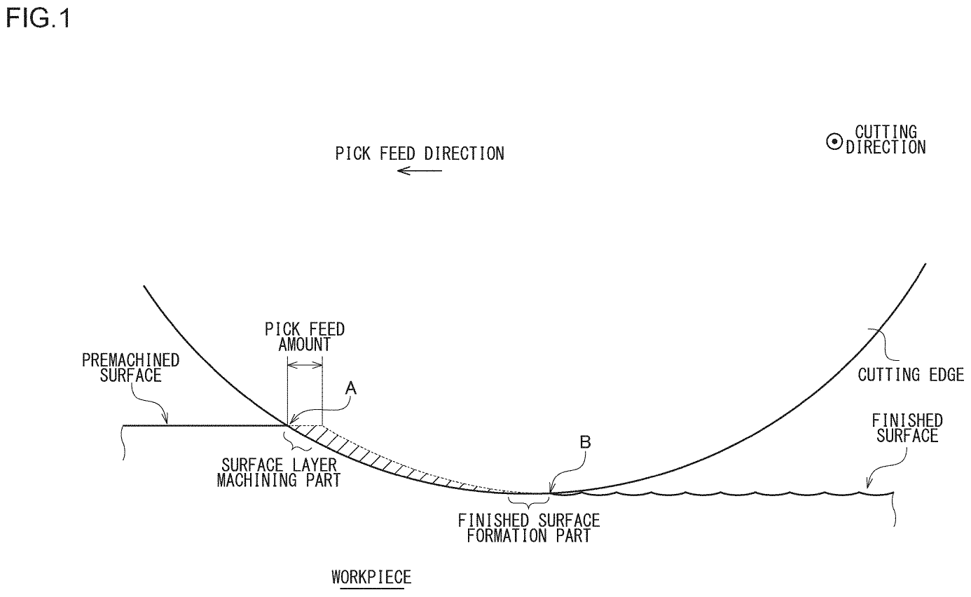

FIG. 1 schematically shows a scene of Experiment 1 where quenched steel subjected to electron-beam-excited-plasma nitriding is machined by planing with a diamond cutting tool. The workpiece has a surface layer quenched and electron-beam-excited-plasma nitrided. As shown in FIG. 1, a cutting edge located between a point A on a premachined surface and a point B on a finished surface is for use in cutting the workpiece, the part of the cutting edge adjacent to the point A cuts the premachined surface, and the part of the cutting edge adjacent to the point B forms the finished surface. In Experiment 1, with a tool orientation fixed without being changed, all cutting process was performed with a cutting edge ridgeline extending from point A to point B.

Machining conditions in Experiment 1 are as follows:

Workpiece: SKD61 (quenched and electron-beam-excited-plasma nitrided);

Pick feed amount: 10 μm/pass;

Depth of cut: 5 to 30 μm;

Cutting speed: 0.8 m/min; and

Cutting edge nose radius: 1.0 mm.

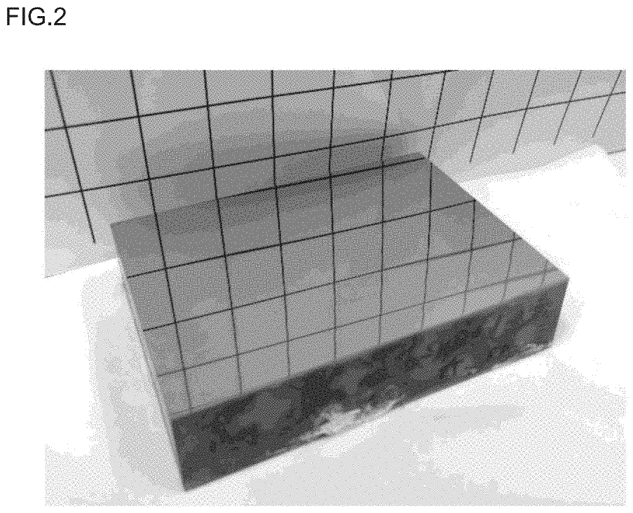

FIGS. 2 to 5 show results of Experiment 1. FIG. 2 is a picture capturing an appearance of a machined object mirror-surface cut under the above-described machining conditions.

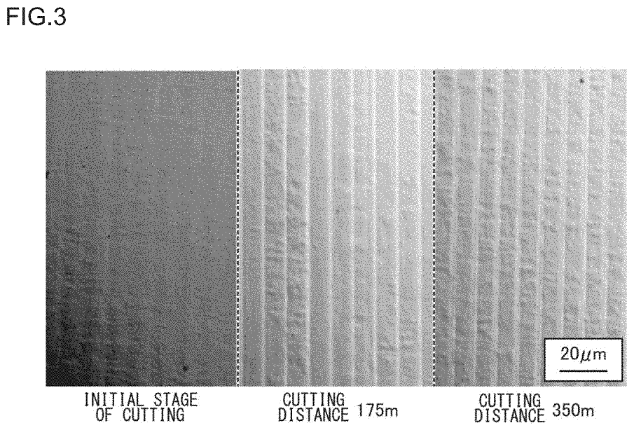

FIG. 3 is a picture capturing a finished surface of the machined object under a differential interference contrast microscope. The differential interference contrast microscope splits light from a light source into two components through a Nomarski prism to illuminate a sample to highlight unevenness of a surface of the sample using interference that occurs when two observation lights reflected from the sample are combined. FIG. 3 shows a finished surface at the initial stage of cutting, a finished surface when the cutting distance is 175 m, and a finished surface when the cutting distance is 350 m, showing that as the cutting distance increases, a feed mark becomes more conspicuous.

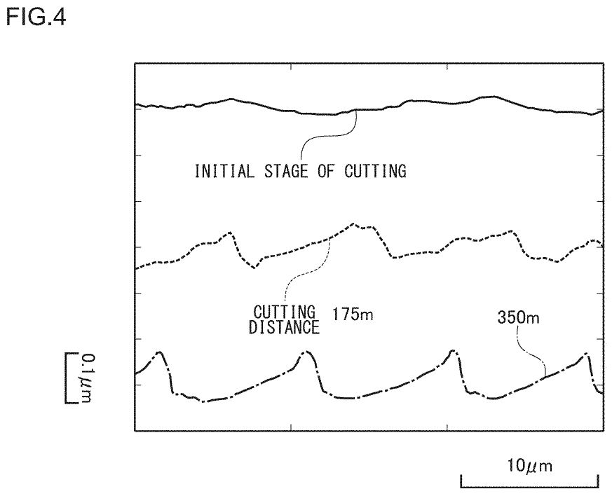

FIG. 4 shows results of measuring a cross-sectional contour of the finished surface in the pick feed direction. The measurement results shown in FIG. 4 show that as the cutting distance increases, the unevenness of the finished surface becomes deeper.

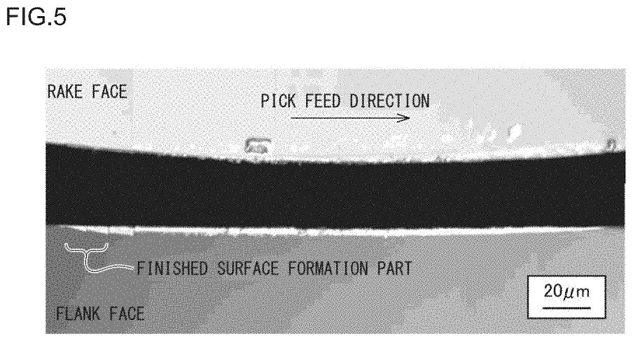

FIG. 5 shows a picture obtained by arranging, like a two-view drawing, pictures capturing the cutting edge of the diamond cutting tool from the rake face side and the flank face side under the microscope when the cutting distance becomes 350 m. Attention given to the flank face side shows that serrate-like wear occurs on a part of a cutting edge for use in forming the finished surface (finished surface formation part) to a degree corresponding to the pick feed amount. This serrate-like wear corresponds to the unevenness of the finished surface (cutting distance 350 m) shown in FIG. 4.

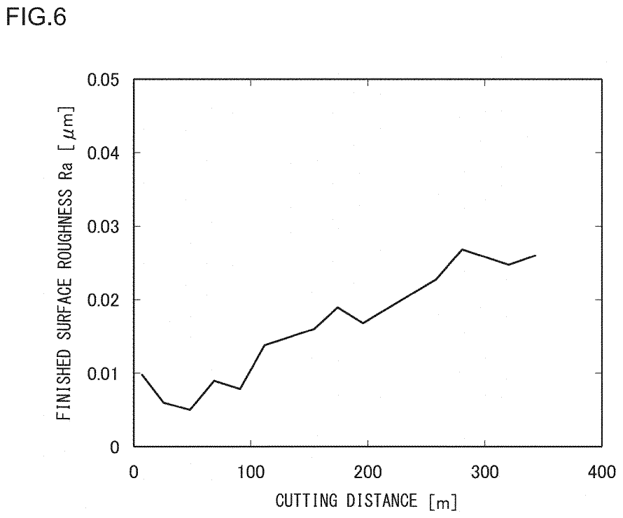

FIG. 6 shows results measuring a relationship between the cutting distance and a finished surface roughness Ra. It is shown that the occurrence of the serrate-like wear on the finished surface formation part of the flank face increases the finished surface roughness Ra in response to an increase in the cutting distance. Note that, in Experiment 1, the surface layer subjected to quenching and electron-beam-excited-plasma nitriding was cut with the diamond tool, but even when a NiP plated layer was cut with the diamond tool, it was observed that similar serrate-like wear occurs on the flank face side and the finished surface is adversely affected.

### Experiment 2

The present discloser conducted, subsequent to Experiment 1, Experiment 2 where quenched steel subjected to a nitriding method different from the electron-beam-excited-plasma nitriding was machined by planing with the diamond cutting tool. The workpiece has a surface layer quenched and nitrided. Also in Experiment 2, all cutting process was performed using the same part of the cutting edge (the cutting edge extending from point A to point B shown in FIG. 1) without changing the tool orientation. Experiment 2 was conducted under the same machining conditions as in Experiment 1 except that the electron-beam-excited-plasma nitriding applied during the preprocessing on the workpiece was replaced with nitriding under the different nitriding method.

Machining conditions in Experiment 2 are as follows:

Workpiece: SKD61 (Quenched and Nitrided)

Pick feed amount: 10 μm/pass;

Depth of cut: 5 to 30 μm;

Cutting speed: 0.8 m/min; and

Cutting edge nose radius: 1.0 mm.

The nitriding performed in Experiment 2 is a type of gas nitriding and may make a nitride layer on the surface thin as compared with conventional gas nitriding. Therefore, it is less likely to cause micro chipping (chipping) in the tool cutting edge due to hard nitride particles as compared with the conventional gas nitriding, but it is likely to generate nitride in the surface layer as compared with the electron-beam-excited-plasma nitriding.

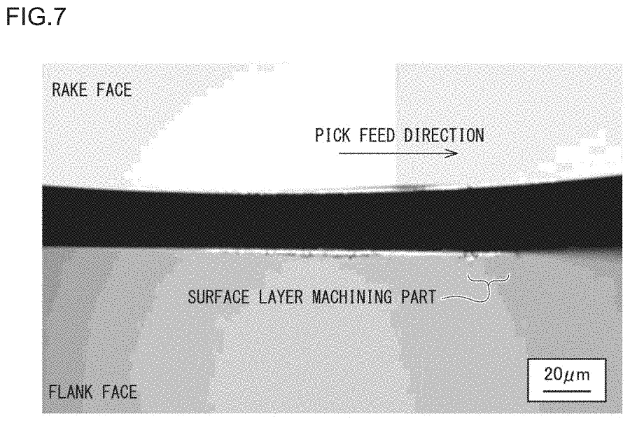

FIG. 7 shows a picture obtained by arranging, like a two-view drawing, pictures capturing the cutting edge of the diamond cutting tool from the rake face side and the flank face side under the microscope when the cutting distance becomes 350 m. With reference to the picture shown in FIG. 7, the amount of wear at the finished surface formation part is smaller than the amount of wear shown in the picture of Experiment 1 shown in FIG. 5, but it is shown that the part of the cutting edge (surface layer machining part) for use in machining the surface layer has micro chipping. From this, the nitriding in Experiment 2 is higher in nitrogen concentration in a nitrogen diffusion layer and higher in effect of suppressing tool wear, but more likely to cause micro chipping of the tool due to the generation of hard nitride in the surface layer than the electron-beam-excited-plasma nitriding.

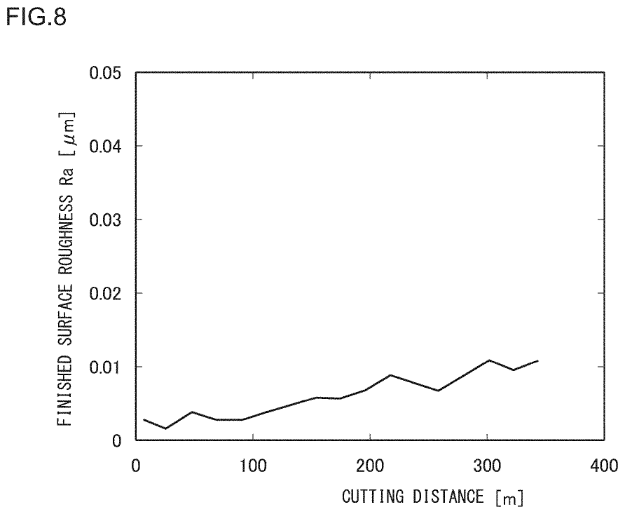

FIG. 8 shows results of measuring a relationship between the cutting distance and the finished surface roughness Ra. In Experiment 2, since the planing process is performed with the tool orientation fixed, the machined surface of the workpiece cut with the surface layer machining part having chipping is cut off in the subsequent pass. A comparison with the measurement results of Experiment 1 shown in FIG. 6 shows that the finished surface roughness Ra relative to the cutting distance increases more gradually in the nitriding performed in Experiment 2 than in the electron-beam-excited-plasma nitriding performed in Experiment 1, and the nitriding performed in Experiment 2 can bring about a more satisfactory finished surface.

However, in practical machining, it is rare to machine only a flat surface with the tool orientation fixed as in Experiment 2, and various curved surfaces are often machined. In such practical machining, a chipped part of the cutting edge is possibly used for forming a finished surface, and the continuous use of the chipped part of the cutting edge becomes a factor in deterioration in accuracy of the finished surface.

Taking the above experiment results into consideration, a description will be given of the machining technique according to the embodiment.

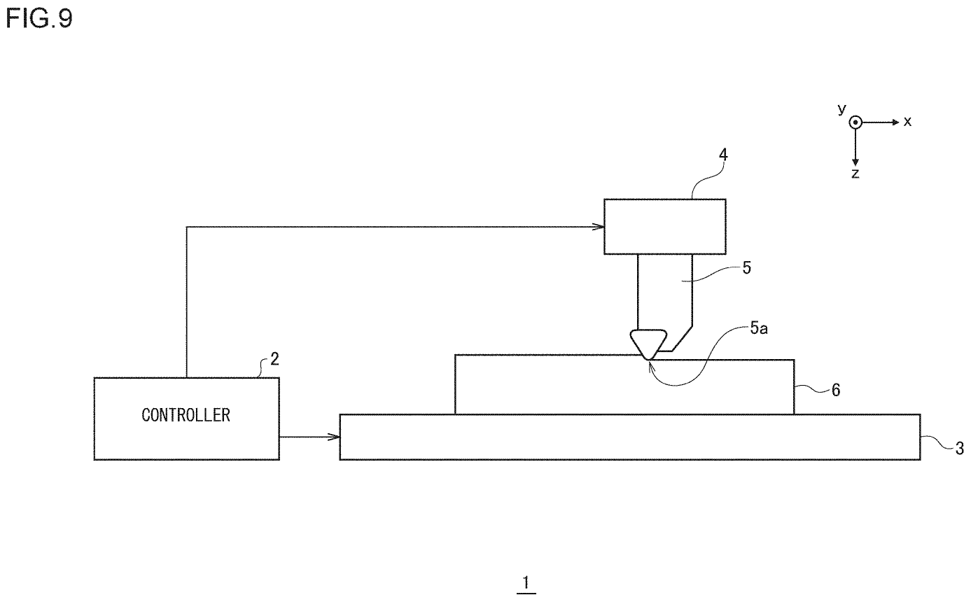

FIG. 9 shows a structure of a machining apparatus 1 according to the embodiment. The machining apparatus 1 is a cutting apparatus structured to perform planing process on a workpiece 6 with a cutting tool 5 having a cutting edge 5a with a convex shape such as an arc shape. In the following, it is assumed that the cutting edge 5a has an arc shape. The machining apparatus 1 includes a holder 4 structured to hold the cutting tool 5 changeable in orientation, a motion mechanism 3 structured to move the workpiece 6 relative to the cutting tool 5, and a controller 2 structured to control a change in orientation by the holder 4 and the relative movement by the motion mechanism 3. The motion mechanism 3 is responsible only for the relative movement between the workpiece 6 and the cutting tool 5, and may move either the workpiece 6 or the cutting tool 5, or alternatively, may move both the workpiece 6 and the cutting tool 5.

The controller 2 is responsible for implementing various functions by executing a machining program for the control described below. The controller 2 may include a CPU, a memory, and other circuit blocks in terms of hardware, and is put into operation by the machining program loaded in the memory in terms of software.

The controller 2 controls the relative movement between the workpiece 6 and the cutting tool 5 by the motion mechanism 3. According to the embodiment, the controller 2 causes the motion mechanism 3 to move the workpiece 6 in the y-axis positive direction with cutting edge 5a cut into the surface of the workpiece 6 to perform cutting for one pass. When the cutting for one pass is completed, the controller 2 causes the motion mechanism 3 to retract the cutting edge 5a in the z-axis negative direction, return the workpiece 6 in the y-axis negative direction, and then move the workpiece 6 in the x-axis positive direction by a pick feed amount corresponding to a feed amount, and causes the motion mechanism 3 to move, with the cutting edge 5a moved in the z-axis positive direction and cut into the surface of the workpiece 6, the workpiece 6 in the y-axis positive direction to perform cutting for the next one pass. The controller 2 repeatedly performs this process to mirror-surface cut the surface of the workpiece 6.

The holder 4 holds the cutting tool 5 rotatable about an axis containing the y-axis component corresponding to the cutting direction. A plane including the arc-shaped cutting edge ridgeline is set orthogonal to the rotation axis. The controller 2 controls the orientation of the cutting tool 5 by controlling the rotation of the holder 4. The controller 2 also controls the position of the motion mechanism 3 when the arc center and the rotation center are misaligned to control a relative angle between the cutting tool 5 and the workpiece 6 about the rotation axis passing through the arc center of the arc-shaped cutting edge ridgeline and orthogonal to the plane including the cutting edge ridgeline. This rotation axis always contains the cutting direction (y-axis) component, and when the plane including the cutting edge ridgeline is orthogonal to the cutting direction (y-axis), the rotation axis is parallel to the y-axis. Note that, according to the embodiment, the holder 4 holds the cutting tool 5 rotatable, but the motion mechanism 3 that holds the workpiece 6 may hold the workpiece 6 rotatable. That is, at least one of the holder 4 that holds the cutting tool 5 or the motion mechanism 3 that holds the workpiece 6 may include a rotation mechanism, and the controller 2 may control the rotation mechanism to control the orientation of the cutting tool 5 relative to the workpiece 6.

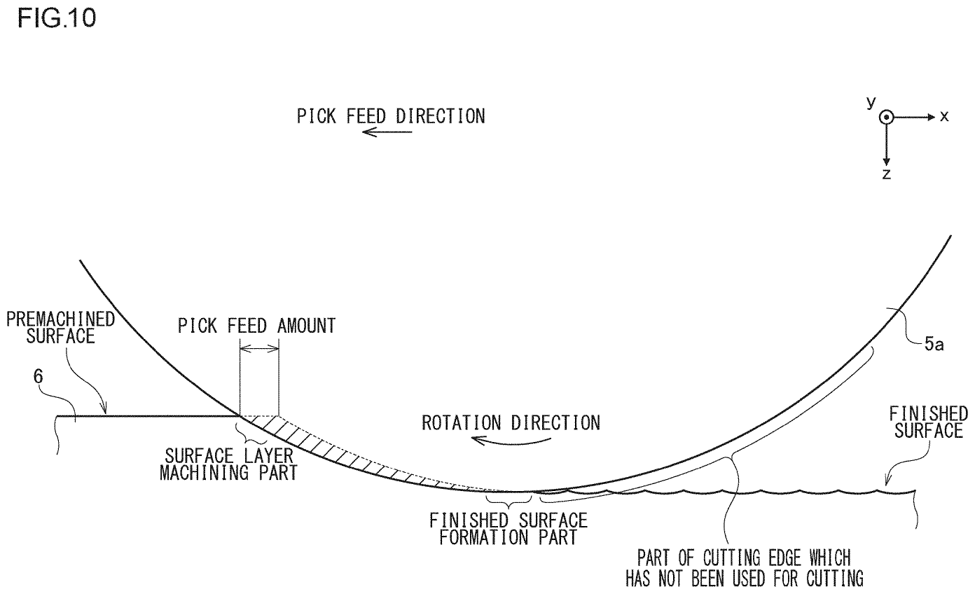

FIG. 10 schematically shows a scene of machining according to the embodiment. According to the embodiment, the controller 2 intermittently or continuously changes the orientation of the cutting tool 5 to perform long-distance cutting on the workpiece 6 while suppressing or avoiding wear on the cutting edge 5a. Specifically, the controller 2 intermittently or continuously rotate the orientation of the cutting tool 5 slightly about the rotation axis passing through the arc center of the arc-shaped cutting edge ridgeline and orthogonal to the plane including the cutting edge ridgeline, so as to cause a part of the cutting edge that has not been used for cutting form the finished surface. In the example shown in FIG. 10, the controller 2 intermittently or continuously rotates the cutting edge 5a in the clockwise direction.

The rotation axis about which the orientation of the cutting tool 5 is rotated needs to contain at least the component in the cutting direction (y-axis), and need not necessarily be parallel to the cutting direction. That is, the rotation axis may be inclined about the x-axis and/or the z-axis, and the part of the cutting edge that has not been used for cutting only needs to be able to move to the next finished surface formation part when viewed in the cutting direction. In other words, even when the rotation axis about which the orientation of the cutting tool 5 is rotated is inclined relative to the cutting direction, it is important that the cutting edge 5a rotates about the arc center of the arc-shaped cutting edge ridgeline when viewed in the axis direction, and the controller 2 only needs to be able to change the orientation of the cutting tool by rotating the cutting tool 5 about the rotation axis containing the component in the cutting direction (y-axis) to cause the part of the cutting edge that has not been used for cutting to form the finished surface.

The movement of a part of the cutting edge that has not been used for cutting to the finished surface formation part causes a new part of the cutting edge to form the finished surface. At the same time, the part of the cutting edge that has been used for machining the premachined surface (to-be-cut surface) at the surface layer machining part moves to a position where the part of the cutting edge is no longer used for cutting. As a result, even when micro chipping occurs in the part of the cutting edge that has been used for machining the premachined surface, it possible to avoid a case where the part of the cutting edge adversely affects the subsequent cutting process.

Note that when controlling the orientation (rotation position) of the cutting tool 5 in conventional practical curved surface machining, the controller 2 changes, in accordance with the machining surface orientation, the orientation of the cutting tool 5 so as to maintain the orientation of the cutting tool relative to the machining surface orientation. The controller 2 according to the embodiment changes not only the orientation (rotation) of the cutting tool 5 in accordance with a change in machining surface orientation, but also the tool orientation (rotation position) so as to move, little by little, the part of the cutting edge 5a located at the finished surface formation part in accordance with the cutting distance or the cutting time.

With reference to FIG. 6, under the machining conditions of Experiment 1, when the cutting distance exceeds 100 m, the finished surface roughness Ra exceeds 0.01 μm. Therefore, in order to form a finished surface with a roughness of 0.01 μm or less over a long distance, it is necessary to make the cutting distance of the finishing process using the same part of the cutting edge equal to about 100 m. Herein, the part of the cutting edge for use in forming the finished surface (the part of the cutting edge at the finished surface formation part) corresponds to a part of the cutting edge having a width equal to the pick feed amount (10 μm) corresponding to the feed amount.

When the controller 2 is structured to intermittently control the orientation, the cutting tool 5 is rotated about the cutting direction by an angle corresponding to the pick feed amount of the cutting edge 5a until the cutting distance of the part of the cutting edge that has been used for forming the finished surface reaches 100 m so as to cause a new part of the cutting edge to form the finished surface. Note that, during the intermittent orientation control, the rotation direction is constant (clockwise in FIG. 10) and does not change to the opposite direction.

Accordingly, the controller 2 changes the orientation of the cutting tool 5 by a change amount (rotation angle) based on the pick feed amount corresponding to the feed amount. Note that the controller 2 may rotate the cutting tool 5 by a rotation angle corresponding to the pick feed amount itself, but the controller 2 may rotate the cutting tool 5 by a rotation angle corresponding to m (m>1) times as large as the pick feed amount. For example, m may be greater than 1 and less than 1.2.

When the cutting edge 5a with a nose radius of 1 mm can be used for cutting over an angle range of 1 rad, for example, this method can evenly disperse wear over the cutting edge ridgeline of 1 mm and can also avoid, even when micro chipping may occur on the premachined surface side, the influence of the micro chipping.

In this case, over a distance, 1 mm/10 μm*100 m=10,000 m, machining can be performed with a finished surface roughness Ra equal to or less than about 0.01 μm. For this calculation, it is assumed that the cutting tool 5 is rotated by an angle (0.01 rad) corresponding to the pick feed amount (10 μm) every time the controller 2 performs machining over a distance of 100 m.

Note that the controller 2 may intermittently change the orientation of the cutting tool by a change amount (rotation angle) based on the pick feed amount when cutting is not performed over the cutting path (that is, every time a single or plurality of pick feeds are made). For example, when machining is performed over a distance of 1 m with 10 passes, the controller 2 may intermittently rotate the cutting tool 5 by a rotation amount corresponding to a rotation angle of 0.0001 rad every time the cutting for 10 passes is completed.

Note that the controller 2 may continuously, rather than intermittently, control the orientation of the cutting tool 5. When performing the continuous orientation control, the controller 2 may continuously rotate the cutting tool 5 by a rotation amount corresponding to, for example, a minimum rotation angle. For example, when. 0.00001 rad is the minimum rotation angle, the controller 2 may rotate the cutting tool 5 by a rotation amount of 0.00001 rad for every cutting distance of 0.1 m. When the controller 2 performs the continuous orientation control, serrate-like wear as shown in FIG. 5 does not occur in the finished surface formation part of the cutting edge 5a, but averaged wear with less unevenness occurs. Therefore, a comparison between the continuous orientation control and the intermittent orientation control shows that, when the rotation angle relative to the cutting distance is constant, the continuous orientation control allows a reduction in unevenness of the finished surface and allows a satisfactory finished surface with less finished surface roughness Ra to be obtained as compared with the intermittent orientation control.

As described above, the controller 2 changes the orientation of the cutting tool 5 by the change amount (rotation angle) based on the cutting distance. Therefore, the controller 2 has a capability of accumulating and holding the cutting distance of the cutting tool 5. When a finished surface profile shown in FIG. 6 is known, the controller 2 may determine the cutting distance and the change amount by which the orientation is changed on the basis of a required finished surface roughness Ra.

When an operator inputs the finished surface profile (see FIG. 6) that defines a relationship between the cutting distance and the finished surface roughness and the required finished surface roughness Ra into the machining apparatus 1, the controller 2 may set, on the basis of the finished surface roughness Ra, an upper limit distance over which cutting is performed with the same part of the cutting edge to determine the cutting distance at which the tool orientation is changed. Note that, according to the embodiment, the controller 2 changes the tool orientation by the change amount based on the cutting distance, or alternatively, may change the tool orientation by a change amount based on a cutting time. This requires the controller 2 to have a capability of accumulating and holding the cutting time for the cutting tool 5. Note that the capability of calculating the cutting distance at which the orientation is changed and the orientation change amount may be implemented by a program generator structured to create an NC program, the cutting distance and the change amount calculated may be embedded in the NC program, and the controller 2 may control the orientation change by the holder 4 and the relative movement by the motion mechanism 3 in accordance with the NC program.

Note that the structure where the cutting tool 5 includes a round cutting tool with the arc-shaped cutting edge 5a has been described above, but the cutting edge 5a may have an elliptical shape or a shape of a multi-order function. Further, the structure where the rotation axis about which the tool orientation is rotated is orthogonal to the plane including the cutting edge ridgeline has been described, but the rotation axis need not necessarily be orthogonal. When the cutting edge 5a has a convex shape other than an arc shape, and/or the rotation axis is not orthogonal to the plane including the cutting edge ridgeline, the controller 2 controls a relative angle between the cutting tool 5 and the workpiece 6 about a center of a circle having a curvature of a curve obtained by projecting the cutting edge ridgeline at the finished surface formation part onto a plane orthogonal to the rotation axis. This rotation axis always contains the cutting direction (y-axis) component, and when the plane including the cutting edge ridgeline is orthogonal to the cutting direction (y-axis), the rotation axis is parallel to the y-axis.

Further, when a target finished surface is flat or approximately flat, the cutting edge 5a may have a polygonal shape, and in this case, the controller 2 controls the tool orientation to make each side of the polygon approximately parallel to the to-be-cut surface and performs machining, changes the tool orientation before the finished surface roughness requirement is not met, and rotates and moves the next new part of the cutting edge, that is, the next side of the polygon, to the finished surface formation part. Further, each side of the polygon may have an arc shape with a large radius of curvature, and in this case, it is possible to obtain a curved finished surface, and further to reduce the height of geometric roughness left on the finished surface or increase machining efficiency by increasing the pick feed for the same roughness height.

According to the embodiment, as an example of the workpiece 6, a die steel having the surface subjected to nitrogen diffusion has been given, but the workpiece 6 is not limited to such a die steel. For example, even when the NiP layer obtained by plating the surface of steel is cut with a diamond tool, the application of the tool orientation control according to the embodiment allows tool wear to suitably disperse and allows a satisfactory finished surface to be obtained over a long cutting distance.

Further, when ultrasonic elliptical vibration cutting is performed on a quenched die material, a hard oxide layer appears on the surface after quenching, and the contour of wear on the tool tends to be influenced by the pick feed. Therefore, the application of the tool orientation control according to the embodiment makes it possible to suppress or avoid tool wear caused by the influences of the hard oxide layer and the influences of the pick feed. As yet another example, when a titanium alloy is cut with a cemented carbide tool, the cutting edge on the premachined surface side is easily worn due to boundary wear, and a wear form of the cutting edge on the finished surface formation side tends to be influenced by the pick feed; therefore, the application, in the similar manner, of the tool orientation control according to the embodiment allows a satisfactory finished surface to be obtained over a long cutting distance.

The present disclosure has been described on the basis of the embodiment. It is to be understood by those skilled in the art that the embodiment is illustrative and that various modifications are possible for a combination of components or processes, and that such modifications are also within the scope of the present disclosure. According to the embodiment, a planing apparatus has been given as the machining apparatus 1, but the machining apparatus 1 may be a cutting apparatus of a different type. When the machining apparatus 1 is a turning apparatus structured to rotate the workpiece 6, the controller 2 changes the orientation of the cutting tool 5 by a change amount (rotation angle) based on the tool feed amount per revolution.

An outline of aspects of the present disclosure is as follows. A machining apparatus according to one aspect of the present disclosure includes a motion mechanism structured to move a workpiece relative to a cutting tool with a convex cutting edge, and a controller structured to control the relative movement between the workpiece and the cutting tool by the motion mechanism and an orientation of the cutting tool. The controller intermittently or continuously changes the orientation of the cutting tool to cause a part of the cutting edge that has not been used for cutting to form a finished surface.

Intermittently or continuously changing the orientation of the cutting tool to cause the part of the cutting edge that has not been used for cutting to form a finished surface allows a satisfactory finished surface to be formed.

The controller may change the orientation of the cutting tool by a change amount based on a cutting distance or a cutting time. Further, the controller may change the orientation of the cutting tool by a change amount based on a feed amount. Further, the controller may change the orientation of the cutting tool by rotating the cutting tool about an axis containing a component in a cutting direction.

A cutting method according to another aspect of the present disclosure includes moving a workpiece relative to a cutting tool with a convex cutting edge, and controlling an orientation of the cuttings tool. In the controlling an orientation, the orientation of the cutting tool is changed intermittently or continuously to cause a part of the cutting edge that has not been used for cutting to form a finished surface.

A program according to yet another aspect of the present disclosure causes a computer to execute a function of moving a workpiece relative to a cutting tool with a convex cutting edge and a function of controlling an orientation of the cutting tool. The function of controlling an orientation may include a function of intermittently or continuously changing the orientation of the cutting tool to cause a part of the cutting edge that has not been used for cutting to form a finished surface.

What is claimed is:

1. A machining apparatus comprising:
a motion mechanism structured to move a workpiece relative to a cutting tool with convex cutting edge; and
a controller structured to control the relative movement between the workpiece and the cutting tool by the motion mechanism and an orientation of the cutting tool, wherein
the controller changes the orientation of the cutting tool by a change amount based on a feed amount to cause a part of the cutting edge that has not been used for cutting to form a finished surface.

2. The machining apparatus according to claim 1, wherein
the controller changes the orientation of the cutting tool by a change amount based on a cutting distance or a cutting time.

3. The machining apparatus according to claim 1, wherein
the controller changes the orientation of the cutting tool by a change amount equal to or less than a change amount corresponding to the feed amount.

4. The machining apparatus according to claim 1, wherein
the controller changes the orientation of the cutting tool by rotating the cutting tool about an axis containing a component in a cutting direction.

5. A cutting method comprising:
moving a workpiece relative to a cutting tool with a convex cutting edge; and
controlling an orientation of the cutting tool, wherein
in the controlling an orientation, the orientation of the cutting tool is changed by a change amount based on a feed amount to cause a part of the cutting edge that has not been used for cutting to form a finished surface.

6. A recording medium storing a program executable by a computer, the program causing the computer to execute:
moving a workpiece relative to a cutting tool with a convex cutting edge; and
controlling an orientation of the cutting tool, wherein
the controlling an orientation includes changing the orientation of the cutting tool by a change amount based on a feed amount to cause a part of the cutting edge that has not been used for cutting to form a finished surface.
